(19) United States
(12) Patent Application Publication
(10) Pub. No.: US 2009/0234967 A1
(43) Pub. Date: Sep. 17, 2009

(54) Method, system, and apparatus for transferring P2P file distribution tasks between devices

(75) Inventors: Kuifei Yu, Beijing (CN); Ning Yang, Beijing (CN); Canfeng Chen, Beijing (CN); Jyri Salomaa, Jorvas (FI)

Correspondence Address: Hollingsworth & Funk, LLC, 8009 34th Avenue South, Suite 125, Minneapolis, MN, 54425, US

(73) Assignee: Nokia Corporation

(21) Appl. No.: 12/077,099

(22) Filed: Mar. 17, 2008

(51) Int. Cl. G06F 15/16

(52) U.S. Cl. 709/232

(57) ABSTRACT

Transferring peer-to-peer (P2P) file distribution tasks involve beginning a file transfer session at a first apparatus via an Internet-based, peer-to-peer, distributed file transfer network. A local connection between the first apparatus and a second apparatus is established via a local network while the file transfer session is ongoing. Data describing remaining tasks of the ongoing file transfer session is transferred to the second apparatus via the local connection. The file transfer session is assumed by the second apparatus via the file transfer network, and the first apparatus then discontinues further tasks related to the file transfer session.

### FIELD OF THE INVENTION

This invention relates to input device interactions related to distributed, peer-to-peer file transfer protocols.

### BACKGROUND OF THE INVENTION

Historically, client-server network infrastructures have dominated both local area networks and wide area networks. Client-server architectures hold many advantages, including facilitating centralized control of content/functionality via the server, relatively simple discovery of resources at well know serving hosts, etc. However, the centralized and well-known location of servers can be a disadvantage in some cases. For example, a well-known high profile server may be a target of malicious activities, such as hacking or denial-of-service attacks. Another example relates to the ability of centralized servers to handle high bandwidth traffic for large numbers of users. When a-highly anticipated content is first made available on a network server, even the most robust centralized service can be made unusable, particularly when the content involves downloading large files (e.g., software distributions, digital movies). In yet another example of disadvantages of centralization, users who value their privacy may object to their networking activities being collected by a centralized service.

In these cases, the advantages of centralized servers, namely centralized and well known computing resources, can sometimes be a disadvantage. Such centralization does not always scale well enough to meet demands from a global network. Further, large centralized entities may be subject to attack because of their notoriety, and the large amounts of (possibly private) data gathered by these entities may be subject to misuse. In response, a number of peer-to-peer (P2P) technologies have been developed in recent years to address these disadvantages of client-server technologies.

Generally, P2P technologies avoid the use of centralized servers for some or all aspects of network communications. P2P may operate at many levels on the network stack, from low-level connectivity (e.g., ad-hoc and mesh wireless networks) to high level user applications (e.g., P2P user-to-user communications and distributed file downloads). In general, a pure P2P network only includes equal peer nodes that may act simultaneously as a “client” and a “server” to the other nodes on the network. Some P2P technologies rely on a mixture of client-server and P2P technologies. For example, the Napster download systems relied on a centralized server to find peers based on content searches, but the actual content downloads are performed between peers.

In realm of the file downloading, systems such as BitTorrent are particularly useful for distributing large files where there is heavy demand for the content contained in the files. To perform a BitTorrent download, users typically download a “torrent” file that may be found using traditional Internet search techniques. The torrent file contains metadata about the files to be shared and a centralized computing node (known as a “tracker”) that coordinates distribution of the shared file. In some so-called “trackerless” systems, every peer acts as a tracker, thus negating the need for a centralized computer to handle coordination duties. In either case, a BitTorrent peer acts as both a client, downloading parts of the target file from (preferably) multiple peers, and a server, uploading to other peers the parts of the file that have already been downloaded. A downloading peer may obtain different parts of the file in parallel from multiple peers, and these different parts are verified and assembled into the target file after all portions are received. After the downloading is complete, the user is asked to keep the client running and thereby continue to contribute to the “torrent” by uploading file segments as needed.

In BitTorrent, the content file to be distributed is first made available for upload by a node called an “initial seeder.” Generally, a “seed” is any node that is capable of providing the at least part of the uploaded file to requesting peers, and the “initial seeder” provides the first full copy to the P2P network. There is some ramp up delay associated with BitTorrent-type distribution, because it takes some time for the data to be uploaded to enough seeds to provide optimal transfer rates. The system also relies on some portion of seeds to remain online and contribute to the torrent even after those computers have finished the download.

Seeds are important to P2P file downloading systems such as BitTorrent because the seeds feed the distributed content throughout the system. This is why a system such as BitTorrent is most successful when there is high demand for a download. At the same time the demand is highest, the greatest number of nodes are also available to contribute to the torrent. Thus, the network bandwidth can be efficiently and widely distributed among the active seeds and reducing bottlenecks that are inherent in server-based downloads under the same conditions.

When interest in obtaining a file has decreased, however, BitTorrent tends to become less efficient. For example, most Internet connections have lower upload than download speeds, and in any event the BitTorrent client may purposely configure the clients by default for slow upload rates to minimize impact to the user hosting the seed. Minimizing impact to the user while uploads continue is important to prevent giving the user a reason to stop hosting the seed. Even where upload speeds of nodes is relatively slow, the combined effect when a large number of multiple parallel seeds are available can result in net download rates that may be greater than those possible from a centralized sever. However, if only a few seeds are available, then the data may be downloaded, but possibly at a transfer rate much less than could be provided by a centralized server depending on the configuration of the seeding peers. In the extreme case, if all the seeds for one file go off line, any peers that want to download this file have to wait for one of the seeds to come online.

Although the slowdown effects are described above in relation to BitTorrent-type systems, other P2P file downloading file systems also use peers with the similar functions and characteristics as BitTorrent seeds. Thus, those systems may also be similarly affected when the number of data-providing nodes decreases. Each peer in a P2P file downloading system has the freedom to disengage from the P2P network at any time. Even users who might wish to-contribute after the file has been downloaded may manually or automatically disengage when, for example, their computers shut off or go to stand-by mode. Thus, there are practical difficulties in decreasing the wait times for this type of distributed P2P download.

Notwithstanding the above, distributed file transfer protocols have been found to be efficient and robust ways to mass distribute digital files. The public's interest in downloading ever greater amounts of content via the Internet will only increase in the future. Therefore, finding ways to decrease wait times for distributed P2P file transfers is desirable.

### SUMMARY OF THE INVENTION

To overcome limitations in the prior art described above, and to overcome other limitations that will become apparent upon reading and understanding the present specification, the present invention discloses a system, apparatus and method for transferring -P2P file distribution tasks between devices. In accordance with one embodiment of the invention, an apparatus includes at least one network interface capable of being coupled to an Internet-based, peer-to-peer, distributed file transfer network and a local network. A processor is coupled to the network interface and memory is coupled to the processor. The memory includes instructions that cause the processor to begin a file transfer session via the file transfer network and establish a local connection with a second apparatus coupled via the local network while the file transfer session is ongoing. The instructions further cause the processor to transfer, to the second apparatus via the local connection, data describing remaining tasks of the ongoing file transfer session. The instructions further cause the processor to facilitate transfer of the remaining tasks of the ongoing file transfer session to the second apparatus; and discontinue further tasks related to the file transfer session.

In more particular embodiments of the apparatus, the instructions further cause the processor to transfer, to the second apparatus, already downloaded segments of s file. In another case, the instructions may further cause the processor to receive, from the second apparatus, additional segments of the file downloaded by the second apparatus after discontinuing the further tasks related to the file transfer session. In such a case, the transfer of the remaining tasks to the second apparatus occurs in response to a stall of the download, and the instructions further cause the processor to power off the apparatus after discontinuing the further tasks related to the file transfer session.

In other, more particular embodiments of the apparatus, the file transfer session and the local connection may utilize different file transfer protocols. The file transfer network may include a BitTorrent network. The local connection may include an XML-based file synchronization protocol such as SyncML.

In another embodiment of the invention, a method involves beginning a file transfer session at a first apparatus via an Internet-based, peer-to-peer, distributed file transfer network. A local connection is established via a local network between the first apparatus and a second apparatus while the file transfer session is ongoing. Data describing remaining tasks of the ongoing file transfer session are transferred, to the second apparatus via the local connection to facilitate the second apparatus assuming the file transfer session via the file transfer network. Further tasks related to the file transfer session are discontinued by the first apparatus.

In more particular embodiments of the method, the second apparatus includes a mobile device, and the method further involves continuing the file transfer session via a mobile data network in response to the mobile device being relocated from the local network after assuming the file transfer session. In such a case, the method may further involve establishing, between the mobile device and a third apparatus, a second local connection via a second local network in response to the mobile device being relocated to the second local network. In addition, the method in this case involves transferring, to the third apparatus via the second local connection, a) second data describing remaining tasks of the ongoing file transfer session, and b) segments of the file already downloaded by the first apparatus and the mobile device, wherein the transferring facilitates the third apparatus in assuming the file transfer session via the file transfer network. Further tasks related to the file transfer session are then discontinued by the mobile device.

In another embodiment of the invention, a computer-readable storage medium includes instructions executable by a processor of an apparatus for: a) beginning a file transfer session at the apparatus via an Internet-based, peer-to-peer, distributed file transfer network; b) establishing a local connection via a local network between the apparatus and a second apparatus while the file transfer session is ongoing; c) transferring, to the second apparatus via the local connection, data describing remaining tasks of the ongoing file transfer session to facilitate assuming the file transfer session by the second apparatus via the file transfer network; and d) discontinuing further tasks related to the file transfer session by the apparatus.

In another embodiment of the invention, a system includes a first apparatus and a second apparatus capable of being coupled via a local network. The first apparatus includes: a) means for beginning a file transfer session via an Internet-based, peer-to-peer, distributed file transfer network; b) means for establishing a local connection via the local network with the second apparatus while the file transfer session is ongoing; and c) means for transferring, to the second apparatus via the local connection, data describing remaining tasks of the ongoing file transfer session. The second apparatus includes means for receiving the data describing remaining tasks of the ongoing file transfer session and means for assuming the file transfer session by via the file transfer network. The first apparatus is configured to discontinue further tasks related to the file transfer session after the second apparatus assumes the file transfer session.

In another embodiment of the invention, an apparatus includes at least one network interface capable of being coupled to an Internet-based, peer-to-peer, distributed file transfer network and a local network. A processor is coupled to the network interface and memory is coupled to the processor. The memory includes instructions that cause the processor to: a) establish a local connection with a second apparatus via the local network while the second apparatus is engaged in an ongoing file transfer session via the file transfer network; b) receive, via the local connection, data describing remaining tasks of the ongoing file transfer session; and c) assume the file transfer session via the file transfer network on behalf of the apparatus.

In more particular embodiments of the apparatus, the instructions further cause the processor to continue the file transfer session via a mobile data network in response to the apparatus being relocated from the local network after assuming the file transfer session. In such a case, the instructions may also further cause the processor to establish, between the apparatus and a third apparatus, a second local connection via a second local network in response to the apparatus being relocated to the second local network. In such a case, the instructions cause the processor to transfer, to the third apparatus via the second local connection, a) second data describing remaining tasks of the ongoing file transfer session, and b) segments of the file already downloaded by the apparatus and the second apparatus. The transfer facilitates assuming the file transfer session by the third apparatus via the file transfer network. The instructions further cause the processor to discontinue further tasks related to the file transfer session by the apparatus.

These and various other advantages and features of novelty are pointed out with particularity in the claims annexed hereto and form a part hereof. However, for a better understanding of the invention, its advantages, and the objects obtained by its use, reference should be made to the drawings which form a further part hereof, and to accompanying descriptive matter, in which there are illustrated and described representative examples of systems, apparatuses, and methods in accordance with the invention.

### BRIEF DESCRIPTION OF THE DRAWING

The invention is described in connection with the embodiments illustrated in the following diagrams.

FIG. 1 is a block diagram illustrating a system according to embodiments of the invention;

FIG. 2 is a block diagram showing example download scenarios according to various embodiments of the invention;

FIG. 3 is a block diagram showing functional components in a system according to embodiments of the invention;

FIG. 4 is a sequence diagram illustrating data exchanges according to embodiments of the invention;

FIGS. 5 is a block diagram illustrating a synchronization data structures according to embodiments of the invention;

FIG. 6 is a block diagram showing an apparatus according to embodiments of the invention;

FIG. 7 is a flowchart showing a procedure according to an embodiment of the invention; and

FIG. 8 is a flowchart showing a more particular procedure according to embodiments of the invention.

### DETAILED DESCRIPTION OF EMBODIMENTS OF THE INVENTION

In the following description of various exemplary embodiments, reference is made to the accompanying drawings that form a part hereof, and in which is shown by way of illustration various embodiments in which the invention may be practiced. It is to be understood that other embodiments may be utilized, as structural and operational changes may be made without departing from the scope of the present invention.

In P2P file downloading community, users keep their personal computer (PC) running continuously to provide a seed for one file, and/or for downloading a file very slow for the sake of too few seeds in the system. These PCs may consume significant amounts of electrical power while performing these tasks. This type of P2P technology, therefore, like any use that requires an unused PC to remain powered on, may not be as environmentally friendly as it should be.

To solve this problem, a embodiments of the present invention are described that allow a P2P file downloading session to be transferred to a less power consuming device, such as mobile phone. Generally, a mobile device and fixed home computer (e.g., PC) may work in concert to coordinate various aspects of a single distributed file transfer between the two devices. In such a case, the P2P file distribution can benefit from the “always on” and “always available” nature of mobile devices to ensure transfers occur more efficiently. Further, because a mobile device typically uses much less power than a non-mobile computing device, the participation of the mobile device can help reduce power consumption associated with the file transfer.

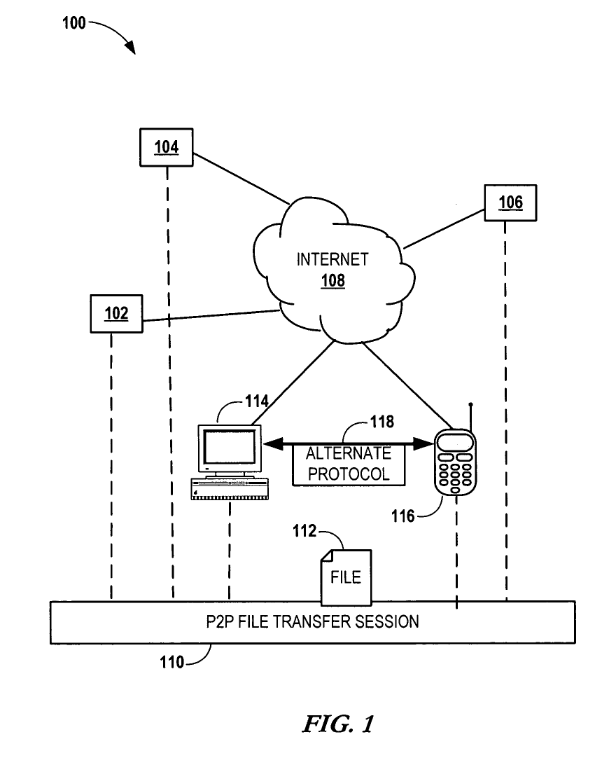

A high-level diagram of a system 100 according to an embodiment of the invention is shown in FIG. 1. Generally, distributed peers 102, 104, 106, 114, 116 are coupled to the Internet 108 (or other network/internetwork) for purposes of engaging in a P2P session 110 to transfer one or more files 112, such as a BitTorrent-type distributed file transfer. The purpose of the session is to distribute the file 112 to/from the peers 102, 104, 106, 114, 116. Two related user devices, shown here as desktop PC 114 and mobile device 116, distribute specific tasks of the single session 110 between the two devices 114, 116.

Generally, the coordination between the PC 114 and mobile device 116 causes the devices 114, 116 perform the functions that are normally carried out by a single device in such a session 110. For example, this may involve devices 114, and 116 handing over an ongoing download from to one device to another. The handovers can be coordinated using a synchronization protocol 118 that may be the same as or different from the protocol of session 110. Further, where the file transfer involves a download to device 114, 116, this protocol 118 can be used to facilitate the re-assembly of the target file 112 from the data on the two (or more) devices 114, 116.

In various embodiments described herein, the transfer protocol 118 between the PC 114 and mobile device 116 may utilize the Open Mobile Alliance Data Synchronization (OMA DS) standard. The OMA DS is a device and network independent standard for synchronized data between two devices. For example, OMA DS is designed to operate over a number of transport protocols, such as Hypertext Transport Protocol (HTTP), (the Wireless Session Protocol (WSP), Bluetooth, IrDA, and other local connectivity. The OMA DS also supports a wide range of data formats, including common personal data formats (e.g., vCard for contact information, vCalendar and iCalendar for calendar, to-do, and journal information), collaborative objects such as e-mail and network news, relational data, XML and HTML documents, binary data, binary large objects (e.g., “blobs”).

The PC 114 and mobile device 116 may be arranged to collect different fragments of a P2P download. This cooperation may be pre-arranged before the download, or be initiated in an ad hoc fashion (e.g., user stops using PC 114 while PC 114 is engaged in download, and decides to transfer remainder of download session 110 to mobile device 116). In either case, fragments of the file 112 resident on the PC 114 and mobile device 116 can be assembled by the OMA DS protocol 118. In another arrangement, the PC 114 to mobile device 116 protocol 118 may be the same as or similar to the P2P protocol of the session 110.

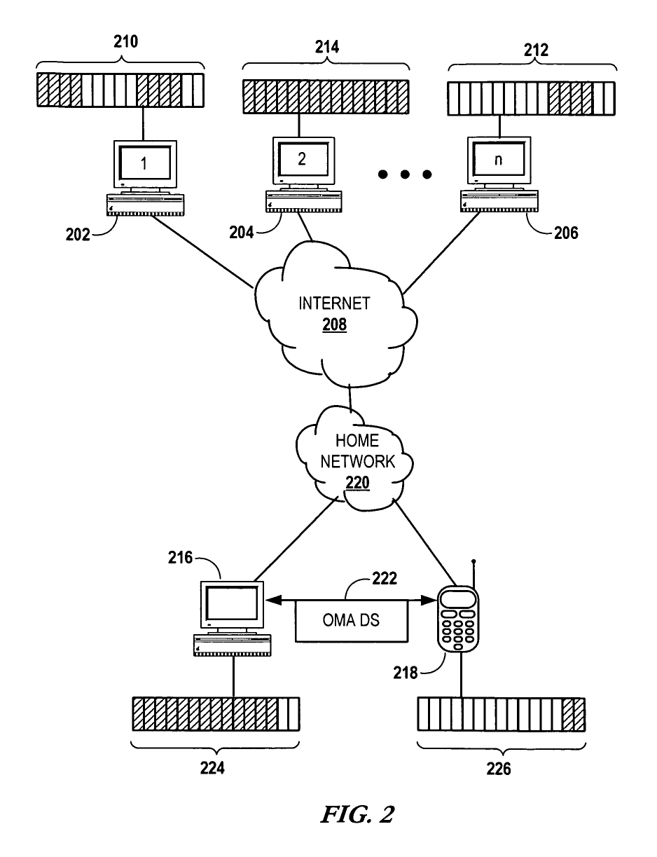

In reference now to FIG. 2, a more particular example of a P2P system according to embodiments of the invention is shown. In this example, n-peers, as represented by peers 202, 204, and 206, are coupled via the Internet 208 to perform distributed P2P file sharing. Each of the peers 202, 204 may still be downloading, as represented by incomplete files 210, 212, respectively (shaded portions of files 210, 212 indicate fragments already downloaded to respective peers 202, 204). Peer 204 already has a compete copy 214 of the file, and may be staying online just to contribute to the P2P file distribution.

A user's PC 216 and mobile device 218 may also be coupled to the Internet 208, such as via home network 220. These devices 216 and 218 cooperate in the P2P distributed file sharing by way of an OMA DS synchronization connection 222. In one example of this cooperation, it may be assumed that the PC 114 has completed most of the downloading, as indicated by file 224, only needing the rightmost fragments (indicated by non-shaded portions of file 224). It may also be assumed that peer 204 is the only peer online that can provide this needed fragment, but 204 may be unavailable for some reason. As a result, the download at PC 216 will appear as stalled (e.g., be shown in a waiting seeds phase on a BitTorrent client). Instead of waiting for the PC 216 to complete the download, the user may wish do something else (e.g., leave the house). Instead of leaving the PC 216 powered on indefinitely, the user can transfer the task of downloading the remaining fragments of the file 224 to the mobile device 218

The user may make a selection from either the PC 216 or mobile device 218 to synchronize the downloading session. Client software on devices 216, 218 that manages the P2P file distribution may have an OMA DS interface to treat the downloading session as one or more synchronizable data objects similar to a contacts list and the like. As such, the user may select to synchronize the current session on the PC 216 with the mobile device 218. Thus when the user stops the download client on the PC 216 (e.g., just before turning the PC 216 off) the mobile device assumes full responsibility for downloading the missing parts of the file 224. After peer 214 again becomes available (or some other peer with the needed fragments appears online) the mobile device 218 may then download the missing fragments as indicated by file 226. Afterwards, the fully downloaded file can be assembled on the PC 216 (or the mobile device 218, if desired) via the OMA DS connection 222 and/or some other file transfer mechanism.

It should be noted that the synchronization between the PC 216 and mobile device 218 at least signals that the mobile device 218 should handle unfinished download tasks of the PC 216. However, the mobile device 218 may also handle other tasks on behalf of the PC 216, such as providing uploads to other peers of the P2P file distribution network. In particular, there may be some benefit to making it appear to peers of the P2P network that the PC 216 and mobile device 218 are the same device. For example, a BitTorrent system provides a “tit-for-tat” crediting system. When trackers (or peers) decide whether to allow download of fragments, they may examine how much data a peer has already contributed to the current torrent, or to previous torrents. As such, it may be beneficial to make the mobile device 218 appear as if it is still the PC 216 requesting the remaining fragments, because the PC 216 may have already accumulated credits that will help the mobile device 218 in completing the download.

In such a case, the synchronization between the mobile device 218 and PC 216 may also involve data that allows the mobile device to assume the identity of the PC 216 to the P2P network. Such data could include high level data (e.g., user id, share ratios, amount of data uploaded for current session, etc.) and/or low level data (e.g., port used for P2P connections, latest TCP frame number). In the latter case, the devices 216, 218 may even attempt to hand over an existing TCP/UDP session in cases where both devices 216, 218 would have the same IP address on the Internet 208. This situation commonly occurs when the home network 220 uses a Network Address Translation (NAT) firewall to connect to the Internet. Those of skill in the art will appreciate that handing over an active connection between devices 216, 218 may involve the cooperation of a NAT firewall in order to work properly, and may also require adaptations at the level of the network stacks of the devices 216, 218.

Another task that could be assumed by the mobile device 218 on behalf of the PC 216 is the uploading of data to the P2P file distribution network. This may involve transferring one or more fragments already downloaded to the PC's file 224 to the mobile device 218. This transfer would likely occur during the initial synchronization between devices 216; 218 and would be completed before the PC 216 is completely shut down. An advantage to this approach is that the mobile device 218 could continue to accumulate credits on behalf of the PC 216. Although the mobile device 218 may be more limited on network bandwidth and/or ability to run on without a recharge, the device 218 by design consumes far less power than the PC 216. Therefore, the mobile device 218 could continue to offer the upload continuously, such as while in a recharge stand or on the go. In particular, as the cost of mobile network access decreases and the capabilities of mobile devices increase, it may be feasible for a user to continuously offer a number of distributed uploads from the mobile device 218 all of the time. Such continuous offering of uploads can solve one problem inherent in a BitTorrent-type distribution scheme, namely the reduction in the number of seeds as demand for a file decreases.

A unique phenomenon in P2P downloading is that every seed publisher would keep seeds for a limited amount of time, such a few days at most. Most of the time, P2P downloaders are only downloading from recently published seeds, because the recently publication causes a spike in demand that facilitates efficient distributed transfer. As a result, older content (e.g., classic movies, games, earlier versions of operating systems) cannot be download just because there are few too peers online at the same time to make the download viable. Even if thousands of people would want the same file at the same time, the odds are low that such people would be on-line and remain on-line at the same instant if there was no immediate -progress in the initial download attempt. This problem can be solved efficiently by using the always-online mobile device 218. If all these people use session transfer, even older content can have thousands of users online at the same time, and downloaders could see a very fast download speed.

The scenario described above can also be used to transfer the download task between the PC 216 and mobile device 218 when the download has not stopped, but has become much slower. In such a case, the user would expect the download to take much longer than anticipated. As a result would use the lower-power, low-bandwidth mobile device 218 and shut down the PC 216, which would otherwise be underutilized and yet still consuming significant power. In another scenario, the PC 216 and mobile device 218 could be synchronized to simultaneously track the download, either by tracking and storing metadata or the actual downloaded data (e.g., simultaneous synchronization via the OMA DS connection 222). In this scenario, the mobile device 218 may be operating as a backup computer in case the PC 216 encounters some sort of failure (e.g., power outage, network outage, OS crash, etc.) The mobile device could pick where the PC 216 left off, such as requiring incomplete fragments, and initiating downloads of fragments not yet obtained.

In the scenario described above, the mobile device 218 could also be used to remotely monitor the download by the PC 216. For example, the ID of the downloaded file pieces may be synchronized to the mobile device 218 via connection 222 so the user could track the download from some other location. It will be appreciated that sync communications 222 between the mobile device 218 and PC 216 can be facilitated even when one or both are outside the local home network 220 by using technologies such as virtual private networking, NAT pass-through, etc. Further, if some event is detected that indicates the PC 216 cannot continue the download (e.g., communications for an uninterruptible power supply that AC power is off), the mobile device 218 could resume the download from its remote location.

In another scenario, the devices 216, 218 can collaborate to download via different paths to further increase download rates. For example, the mobile device 218 may have an alternate path (not shown) to the Internet 208, such as via a 3G cellular network. The PC 216 and mobile device 218 could preallocate some portion of the download to one or other of the devices 216, 218, and the devices 216, 218 could independently gather those fragments via the separate paths. While the fragments are being gathered or afterwards, the devices 216, 218 could transfer their own gathered fragments (e.g., fragments in files 224, 226) to one or both devices 216, 218 to create a completed version.

In yet another scenario described in relation to FIG. 2, the user may use the synchronization via connection 222 between the mobile device 218 and PC to have the download “follow” the user through his or her day. For example, the PC 216 may be at home in the morning and the user begins downloading a movie for watching later that night. The user transfers the download tasks (as well as already downloaded content 224) to the mobile device 218, and drives to a summer cabin. The mobile device 218 continues the download as best it can while on the road. The user then arrives at the cabin and sets up a laptop (not shown) which is also capable of communicating with device 218 via OMA DS. The download tasks and content are transferred from the mobile device 218 to the laptop via a proximate connection (e.g., WiFi, Bluetooth) and the laptop continues the download to completion while the user is out fishing. By the end of the day, the movie is fully downloaded to the laptop for viewing.

As is known in the art, OMA DS is a popular protocol commonly implemented to sync data such as vCards, do-to lists, and the like. The OMA DS has been extensively implemented on many computing platform, especially mobile phones The OMA DS specification defines a framework for synchronizing data sets between two heterogeneous computing devices by different communication techs such as HTTP, WAP, or OBEX (can work on Bluetooth). The framework describes the computing modules on each side of the synchronization and the synchronization messages transferred between devices. In reference to the present invention, the OMA DS framework is extended to synchronize the file blocks of a P2P distributed file download between two devices.

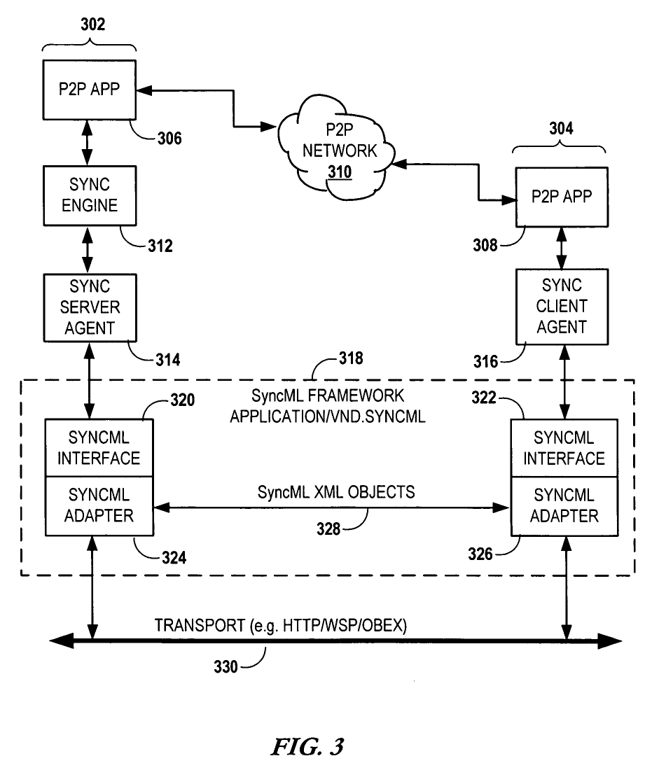

In reference now to FIG. 3, a diagram shows components for facilitating synchronization of P2P downloads using the OMA DS framework according to an embodiment of the invention. Two peers 302, 304 facilitate-sharing P2P file transfer tasks via P2P applications 306, 308. The peers 302, 304 may include any combination of software and hardware capable of running in user devices (e.g., PC 216 and mobile device 218 shown in FIG. 2). The applications 306, 308 provide the logic and interfaces for communicating via protocols of a P2P network 310, such as BitTorrent protocols/networks. The sharing of P2P tasks between the peers 302, 304 are facilitated by sync engine 312 and sync server agent 314 associated with application 306, and sync client agent 316 associated with application 308. As the designation server agent and client agent may indicate, and the agents 314, 316 may perform as traditional client and server. For example the server agent 314 may include an interface that waits for asynchronous connections from the client 316, and in response to such connections the sync engine 312 may coordinate states, events, and data associated with synchronization of P2P tasks undertaken by the peers 302, 304.

It will be appreciated that the agents 314, 316 may also be configured as true peer agents, such that each agent 314, 316 may perform both client and server tasks. As such, the synchronization controlling functions performed by the sync engine 312 may also be distributed between peers 302, 304. However, even where the synchronization components 312, 314, 316 are use a P2P configuration to intercommunicate, the components 312, 314, 316 may still use techniques and protocols that are independent of the P2P network 310. Thus, although the applications 302, 304 themselves may operate in a way that is particularly suited for the P2P network 310, no such constraint need be placed on the components 312, 314, 316.

In particular, server and client agents 314, 316 may utilize a SyncML framework 318 to accomplish low level data synchronization on behalf of agents 302, 304. The term “SyncML” is the former name for OMA DS, and still used commonly used to describe existing software libraries and components within the OMA DS framework. As the name indicates, SyncML (and thus OMA DS) utilize the eXtensible Markup Language (XML) for data synchronization. The peers 302, 304 include respective SyncML interfaces 320, 322 that allow the sync server and clients 314, 316 to utilize the functionality provided by the framework 318. The interfaces 320, 322 may include any combination of source code, object files, libraries, Application Programming Interfaces (API), Interprocess Communications (IPC) interfaces, etc., accessible by the agents 314, 316.

The SyncML interfaces 320, 322 communicate with respective SyncML adapters 324, 326 that handle the data synchronization through the exchange of SyncML XML objects 328. The SyncML adapters 324, 326 may utilize one or more lower level transport layers 330 to effect the data synchronization 328. The SyncML adapter 324, 326 may generically communicate with the interfaces 320, 322, such that the specifics of the transport layer 330, (e.g., protocols, media, network technology, etc.) can be hidden from the interfaces 320, 322. As such, the sync agents 314, 316 may be usable with different instantiations of the SyncML framework 318, and vice versa.

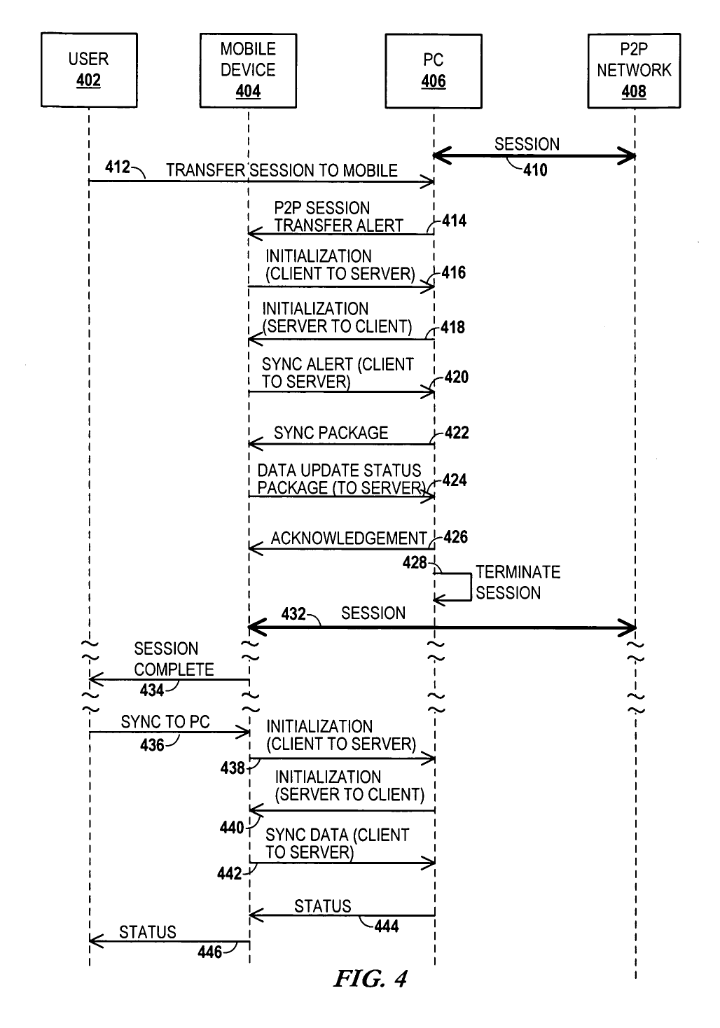

In reference now to FIG. 4, a sequence diagram illustrates an example scenario for synchronizing between a client and a server according to an embodiment of the invention. In this diagram, a user interacts with a mobile device 404 and a PC 406 to synchronize P2P file transfer operations taking place with a P2P network 408. The PC 406 is engaged in an ongoing download and/or upload session 410 with the network 408. Although the network 408 is shown as a single entity, those skilled in the art will appreciate that the network 408 may include a number of hosts, each host having a separate connection to the PC 406.

In this scenario, a synchronization client (e.g., client agent 316 shown in FIG. 3) is running on the mobile device 404 and a synchronization server (e.g., server agent 314 shown in FIG. 3) is running on the PC 406. For any of the reasons as described herein, the user 402 sends a command 412 to the PC 406, telling the PC to handover the remaining tasks of the session 410 to the mobile device 404. In other embodiments, the command 412 may be sent to the mobile device 404, although additional communications with the PC 406 may be required so that the user 402 and mobile device 404 may determine/select which of the PC's sessions (there may be more than one) is to be handed-over. In response to the user request 412, the PC 406 sends a session transfer alert 414 to the mobile device, thereby initiating synchronization with the mobile device 404.

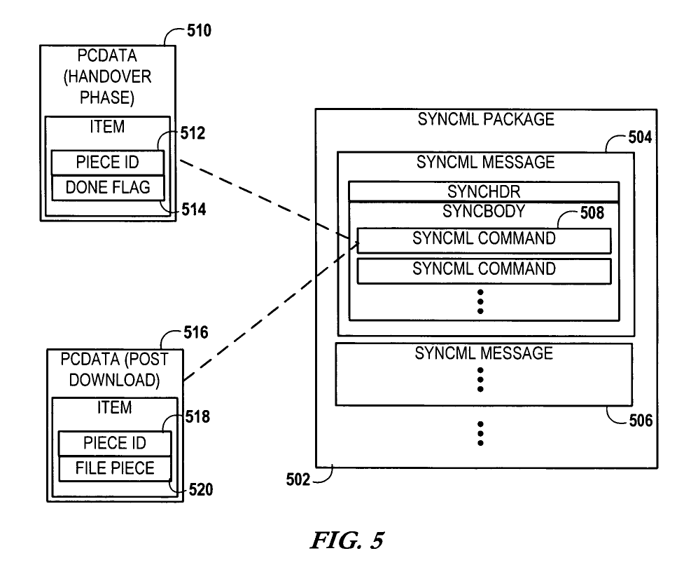

After the alert 414 is sent to the mobile device 404, both devices 404, 406 are aware of an upcoming handover, and exchange initialization 416, 418 data as needed. Such initialization data 416, 418 may include, for example, a session identifier, specification of synchronization transport, etc. The mobile device 404 sends an alert 420 to the PC 406 and in response the PC 406 sends sync data package 422 that describes the current parameters needed to take over the session 410. An example of the content and format of these parameters 422 will be described hereinbelow in relation to FIG. 5.

The mobile device sends an update 424 to the PC 406 regarding the status of the handover. Assuming the handover status 424 was successful, the PC 406 will acknowledge 426 and do whatever actions are needed to terminate 428 the PC's part of the session. Note that the termination 428 may also involve some communications (not shown) with the P2P network 408 and/or intermediary devices (e.g., router, firewall, etc). Contemporaneously with the PC's termination 428 of the session, the mobile device 404 assumes its part of the session 432. When the mobile device 404 has completed the session 432, the completion status is communicated 434 to the user 402.

At some time after the mobile device 404 has completed the session 432, the user 402 may then command 436 the mobile device 404 to sync back up with the PC 406. In response, the client of the mobile device 404 and the server of the PC 406 exchange initialization data 438, 440, and the sync data 442 is sent to the PC 406 to complete the data needed on that device. The status 444 of the synchronization phase is communicated to the mobile device 404, which also notifies 446 the user 402. It will be appreciated that other synchronization data may be sent from the PC 406 to the mobile device 404. For example, the PC 406 may send already downloaded file segments obtained from session 410, such that the mobile device 404 has a full copy of the data upon-completion of the download session 432. This PC-mobile data transfer may occur during the handover phase (e.g., when sync data 422 is sent) or during post download phase (e.g., when sync data 442 is sent).

In the scenario shown in FIG. 4, it may be assumed that the P2P downloading system supports resuming a “broken” download, such as where sessions 410 and 432 are discontinuous in time and/or in peer identity. The file downloading system may support such a resumption of an interrupted download by dividing the file to a number of blocks, each block having a unique ID. Thus, in such a case, the mobile device 404 and PC 406 may transfer two kinds of data to transfer the session: 1) the source or system info of the file download system; and 2) which file blocks have been downloaded and/or which blocks have not been downloaded. In a SyncML embodiment, the number of each of these blocks can be modeled as an item, such as a vCard file item. This data can be used to both obtain the missing blocks of data from the P2P network 408 and thereafter sync the downloaded file blocks between the user devices 404, 406. Note that, as defined by OMA DS, the devices 404, 406 can sync the file blocks from one device to the other, or vice versa (one-way sync), or sync to each other (full sync).

Shown in FIG. 5 is a diagram of an example data structure usable to perform this type of SyncML synchronization according to an embodiment of the invention. A SyncML package 502 includes one or more SyncML messages 504, 506. This data package 502 may be sent, for example, in the sync operations 422, 442 shown in FIG. 4. In a body of message 504, one or more commands 508 are used to sync individual pieces of data. An example command payload 510 that may be transferred in the handover phase (e.g., operation 422 in FIG. 4) includes an ID 512 of the piece/fragment of the download, and a flag 514 that indicates whether this piece/fragment has yet been downloaded. In the post-download phase (e.g., operation 442 in FIG. 4), an example payload 516 may include the ID 518 along with the actual data 520 of the piece/fragment.

File blocks are one type of data that facilitates coordinating file downloading sessions between two or more devices. Another aspect of a file downloading session is data that describes the source of the file, the file IDs, and other data that is specific to the P2P protocol specific. In BitTorrent system, the torrent file (usually named with a *.torrent extension) contains the meta-data of this aspect of the session. So in addition to the data illustrated in FIG. 5, the torrent file may also be transferred to another device as part of the session handover.

The solutions described involve using specialized P2P file downloading software that runs on different kinds of devices. Various cross-platform P2P download software is known, such as in the open source community. Other devices, such as Symbian OS based telephones (e.g., Nokia™ S60) may include a P2P downloading client. This-P2P software may be modified integrate with the OMA DS protocol, which has also been implemented on a wide variety of devices. It is possible using known techniques to adapting these existing P2P programs to include OMA DS extensions for synchronizing P2P downloading files as described herein.

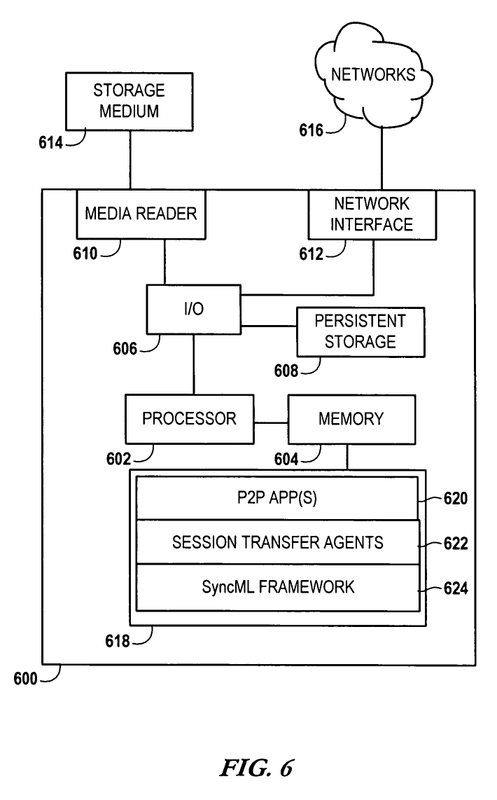

In reference now to FIG. 6, a block diagram illustrates an apparatus 600 that may perform P2P file transfer session coordination according to embodiments of the invention. The apparatus 600 may include a processor 602, memory 604, and an I/O bus 606 that couples peripheral devices to the processor 602. Those peripheral devices may include persistent memory storage 608 (e.g., disc drives, flash memory), one or more network interfaces 612, and a media reader 610 (e.g., tape reader, floppy drive, Compact Disc player, Digital Versatile Disc player, memory card reader, etc.). The media reader 610 is capable of reading from a storage medium 614, such as optical or magnetic media. The media reader 610 may also be capable of writing to the media 614. The network interfaces 612 may be capable of communicating via one or more networks 616. The networks 616 may utilize such media such as phone lines, coaxial cable, Ethernet, wireless radio transmissions, infrared transmissions, etc. The networks 616 may include Internet Protocol (IP) based public and private networks, as well as proximity networking such as Bluetooth and IRDA.

The operation of the processor 602 is dictated by instructions 618 that may be stored temporarily or permanently in memory 604 or other logic circuitry. The instructions 618 may be built into to the apparatus 600 during manufacture, or may be later transferred to the apparatus 600 via the storage media 614 or the networks 616. The instructions 618 include one or more P2P distributed file transfer applications 620 that are capable of engaging in distributed transactions via the networks 616, such as via the BitTorrent protocol. The applications 620 are modified to include session transfer agents 622 that facilitate transferring a P2P file upload/download session to another device, and/or assuming a P2P file upload/download from another device. The underlying specifics of session handover and data synchronization may be accomplished by an implementation of the SyncML framework 624 that is resident on the apparatus 600. Some other XML-based synchronization protocol may also be used in place of the framework 624.

The apparatus 600 may be configured as a mobile device, in which case the apparatus 600 usually includes a self contained power supply (e.g., batteries, solar cells, fuel cells) and a wireless network interface 612. In other embodiments, the apparatus 600 may be configured as a fixed device, such as a PC, server, set top box, media server, consumer appliance, etc. The apparatus 600 may include other well-known features that are not illustrated, such as user input devices, user output devices, power circuitry, sensors, etc.

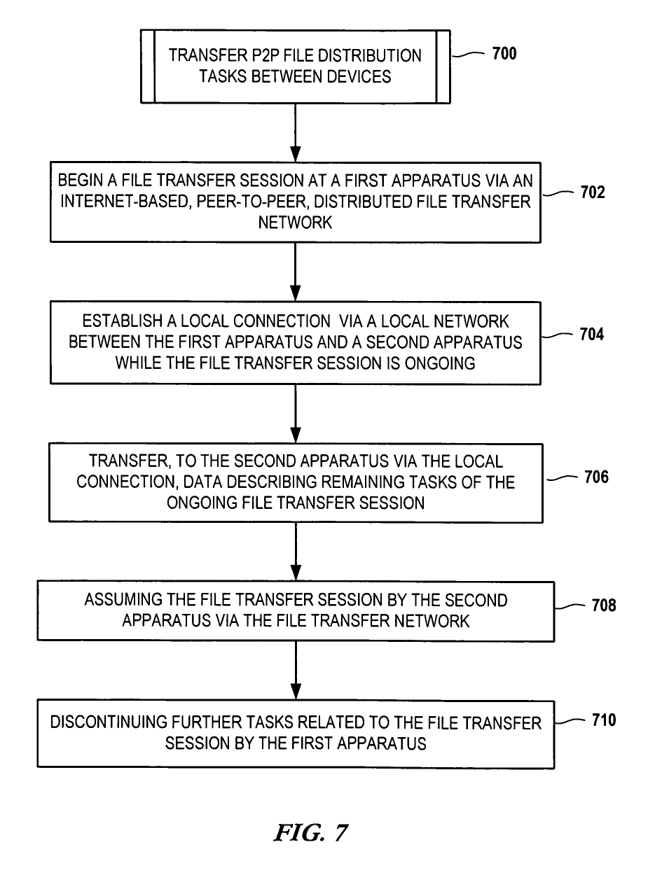

In reference now to FIG. 7, a flowchart illustrates a procedure 700 for transferring P2P file distribution tasks according to an embodiment of the invention. A file transfer session is begun 702 at a first apparatus. The transfer session utilizes an Internet-based, peer-to-peer, distributed file transfer network, such as a BitTorrent download network. A local connection between the first apparatus and a second apparatus is established 704 via a local network while the file transfer session is ongoing. This local connection may use, for example, an XML-based file synchronizing protocol such as SyncML. Data describing remaining tasks of the ongoing file transfer session is transferred 706 to the second apparatus via the local connection. The file transfer session is assumed 708 by the second apparatus via the file transfer network. Further tasks related to the file transfer session are discontinued 710 by the first apparatus. This may allow the first apparatus, for example, to power down in order to save on electricity.

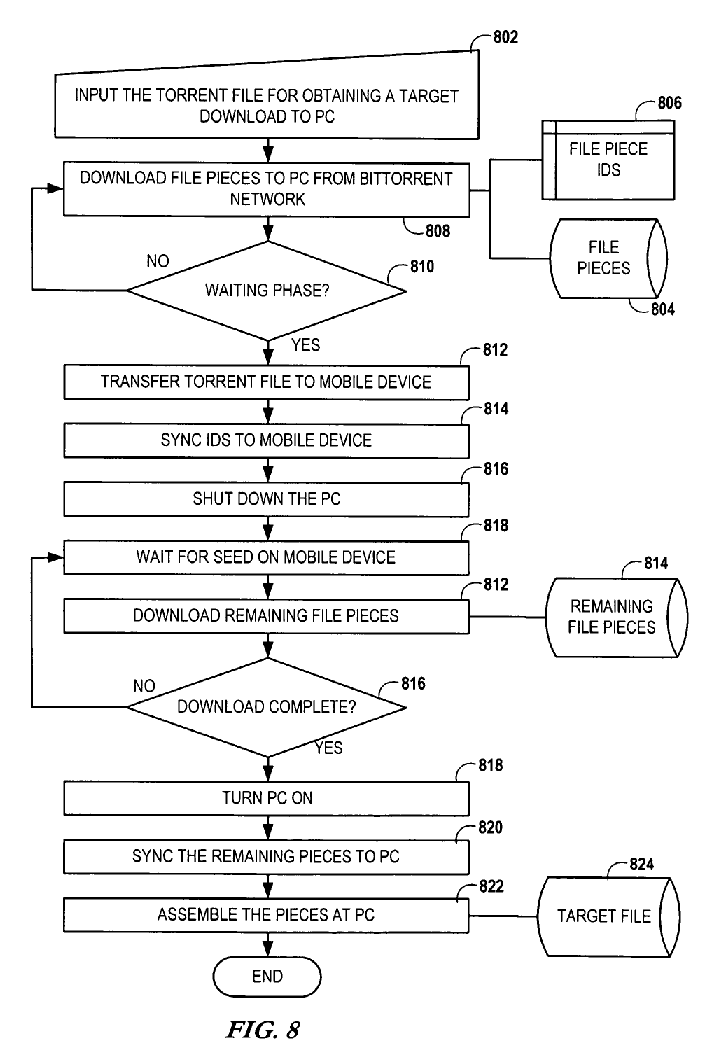

In reference now to FIG. 8, a flowchart illustrates a more particular procedure 800 handing over a BitTorrent P2P file distribution download session according to an embodiment of the invention. The procedure involves inputting 802 a torrent file that facilitates obtaining a target download to a PC. The pieces 804 of the target file and IDs 806 of the pieces are downloaded 808 to the PC. If it is determined 810 that the download is in a waiting phase (e.g. stalled due to lack of an online BitTorrent seed) the torrent file is transferred 812 to the mobile device. The torrent file will provide general information about the file, such as identity of the tracker, target file name, total size, etc. The IDs are also synchronized 814 between the PC and mobile device, which may involve communicating IDs that have not been downloaded, and/or IDs that have been downloaded.

After the IDs have been synchronized 814, the PC may be shut down 816. This shutdown 816 may involve completely powering down the PC, or putting the PC in a low-power standby state. Thereafter, the mobile device waits 818 for a seed. When the seed is back on line, the mobile can continue to download 812 the remaining file pieces 814 that were not obtained by the PC. This continues until it is determined 816 that the download is complete. At some time after the download is complete 816, the PC can be turned back on 818 and the remaining pieces 814 can be synchronized 820 to the PC (and/or the mobile device). The PC (and/or the mobile device) can assemble 822 the pieces to form the target file 824.

It will be appreciated by those skilled in the art that many variations to the procedure in FIGS. 7 & 8 are possible. For example, in the procedure shown in FIG. 8, the PC shutdown 816 may involve putting the PC in a low power state. The PC may be able to wake up from this state, such as via a wake up signal sent by local network (e.g., wake on LAN feature). When the mobile device detects 818 that one or more seeds are back online, the mobile device may wake up the PC, and then transfer some or all of the remaining download session tasks back to the PC. This re-transfer of the session from the mobile device back to the original device may be done in a way similar to step 812, 814 that were used to transfer the session to the mobile device.

In another variation, the synchronization of IDs 814 may also involve sending the already downloaded file pieces to the mobile device. In that scenario, the mobile device may be able to reassemble the target file 824 on its own without any further synchronization 820. In yet another variation, the initial download 808, 810 may occur at a mobile device, and the session may be transferred 812, 814 to the PC or some other device. This may be useful, for example, where the mobile device is low on power and a batter charger is unavailable. The mobile device can then be powered down and the pieces transferred to this other device. The remaining pieces 814 can later be transferred back to the mobile device, either after a recharge, or by using a high-bandwidth local connection that allows the remaining pieces to be transferred on existing battery power.

As will be apparent from reading the above disclosure, embodiments of the invention may be implemented using data processing devices. The functionality of these devices may be realized through the use of instructions that are stored to memory and executed on one or more central processing units. These instructions may be stored and distributed in any form known in the art, including computer readable medium such as magnetic or optical media. The instructions may also be transmitted to the target devices via wired or wireless networks.

The foregoing description of the exemplary embodiments of the invention has been presented for the purposes of illustration and description. It is not intended to be exhaustive or to limit the invention to the precise form disclosed. Many modifications and variations are possible in light of the above teaching. It is intended that the scope of the invention be limited not with this detailed description, but rather determined by the claims appended hereto.

What is claimed is:

1. An apparatus comprising:
at least one network interface capable of being coupled to an Internet-based, peer-to-peer, distributed file transfer network and a local network;
a processor coupled to the network interface; and
memory coupled to the processor, wherein the memory includes instructions that cause the processor to:
begin a file transfer session via the file transfer network;
establish a local connection with a second apparatus coupled via the local network while the file transfer session is ongoing;
transfer, to the second apparatus via the local connection, data describing remaining tasks of the ongoing file transfer session;
facilitate transfer of the remaining tasks of the ongoing file transfer session to the second apparatus; and
discontinue further tasks related to the file transfer session.

2. The apparatus of claim 1, wherein the file transfer session comprises a download of a file, and wherein the instructions further cause the processor to transfer, to the second apparatus, already downloaded segments of the file.

3. The apparatus of claim 1, wherein the file transfer session comprises a download of a file, and wherein the instructions further cause the processor to receive, from the second apparatus, additional segments of the file downloaded by the second apparatus after discontinuing the further tasks related to the file transfer session.

4. The apparatus of claim 3, wherein the transfer of the remaining tasks to the second apparatus occurs in response to a stall of the download, and wherein the instructions further cause the processor to power off the apparatus after discontinuing the further tasks related to the file transfer session.

5. The apparatus of claim 1, wherein the file transfer network comprises a BitTorrent network.

6. The apparatus of claim 1, wherein the local connection comprises an XML-based file synchronization protocol.

7. The apparatus of claim 6, wherein the XML-based file synchronization protocol comprises SyncML.

8. The apparatus of claim 1, wherein the file transfer session and the local connection utilize different file transfer protocols.

9. A method comprising:
beginning a file transfer session at a first apparatus via an Internet-based, peer-to-peer, distributed file transfer network;
establishing a local connection via a local network between the first apparatus and a second apparatus while the file transfer session is ongoing;
transferring, to the second apparatus via the local connection, data describing remaining tasks of the ongoing file transfer session to facilitate the second apparatus assuming the file transfer session via the file transfer network; and
discontinuing further tasks related to the file transfer session by the first apparatus.

10. The method of claim 9, wherein the file transfer network comprises a BitTorrent network.

11. The method of claim 9, wherein the local connection comprises a SyncML data synchronization connection.

12. The method of claim 9, wherein the file transfer session comprises a download of a file, the method further comprising transferring, from the first apparatus to the second apparatus, already downloaded segments of the file.

13. The method of claim 9, wherein the file transfer session comprises a download of a file, the method further comprising receiving, by the first apparatus, additional segments of the file downloaded by the second apparatus after discontinuing the further tasks related to the file transfer session by the first apparatus.

14. The method of claim 13, wherein the transfer of the remaining tasks to the second apparatus occurs in response to a stall of the download, and where the instructions further cause the processor to power off the first apparatus after discontinuing the further tasks related to the file transfer session.

15. The method of claim 13, wherein the second apparatus comprises a mobile device, the method further comprising continuing the file transfer session via a mobile data network in response to the mobile device being relocated from the local network after assuming the file transfer session.

16. The method of claim 15, further comprising:
establishing, between the mobile device and a third apparatus, a second local connection via a second local network in response to the mobile device being relocated to the second local network;
transferring, to the third apparatus via the second local connection, a) second data describing remaining tasks of the ongoing file transfer session, and b) segments of the file already downloaded by the first apparatus and the mobile device, wherein the transferring facilitates the third apparatus in assuming the file transfer session via the file transfer network; and
discontinuing further tasks related to the file transfer session by the mobile device.

17. The method of claim 9, wherein the file transfer session and the local connection utilize different file transfer protocols.

18. A computer-readable storage medium including instructions executable by a processor of an apparatus for:
beginning a file transfer session at the apparatus via an Internet-based, peer-to-peer, distributed file transfer network;
establishing a local connection via a local network between the apparatus and a second apparatus while the file transfer session is ongoing;
transferring, to the second apparatus via the local connection, data describing remaining tasks of the ongoing file transfer session to facilitate assuming the file transfer session by the second apparatus via the file transfer network; and
discontinuing further tasks related to the file transfer session by the apparatus.

19. A system comprising:
a first apparatus and a second apparatus capable of being coupled via a local network, the first apparatus, comprising:
means for beginning a file transfer session via an Internet-based, peer-to-peer, distributed file transfer network;
means for establishing a local connection via the local network with the second apparatus while the file transfer session is ongoing; and
means for transferring, to the second apparatus via the local connection, data describing remaining tasks of the ongoing file transfer session;
wherein the second apparatus comprises:
means for receiving the data describing remaining tasks of the ongoing file transfer session; and
means for assuming the file transfer session by via the file transfer network; and
wherein the first apparatus is configured to discontinue further tasks related to the file transfer session after the second apparatus assumes the file transfer session.

20. An apparatus comprising:
at least one network interface capable of being coupled to an Internet-based, peer-to-peer, distributed file transfer network and a local network;
a processor coupled to the network interface; and
memory coupled to the processor, wherein the memory includes instructions that cause the processor to:
establish a local connection with a second apparatus via the local network while the second apparatus is engaged in an ongoing file transfer session via the file transfer network;
receive, via the local connection, data describing remaining tasks of the ongoing file transfer session; and
assume the file transfer session via the file transfer network on behalf of the apparatus.

21. The apparatus of claim 20, wherein the file transfer session comprises a download of a file, and wherein the instructions further cause the processor to receive, from the second apparatus, already downloaded segments of the file.

22. The apparatus of claim 20, wherein the file transfer session and the local connection utilize different file transfer protocols.

23. The apparatus of claim 20, wherein the file transfer session comprises a download of a file, and wherein the instructions further cause the processor to send, to the second apparatus, additional segments of the file downloaded by the apparatus after assuming the file transfer session.

24. The apparatus of claim 23, wherein the instructions further cause the processor to continue the file transfer session via a mobile data network in response to the apparatus being relocated from the local network after assuming the file transfer session.

25. The apparatus of claim 24, wherein the instructions further cause the processor to:
establish, between the apparatus and a third apparatus, a second local connection via a second local network in response to the apparatus being relocated to the second local network;
transfer, to the third apparatus via the second local connection, a) second data describing remaining tasks of the ongoing file transfer session, and b) segments of the file already downloaded by the apparatus and the second apparatus, wherein the transfer facilitates assuming the file transfer session by the third apparatus via the file transfer network; and
discontinue further tasks related to the file transfer session by the apparatus.
